(19) United States
(12) Patent Application Publication
(10) Pub. No.: US 2013/0056215 A1
(43) Pub. Date: Mar. 7, 2013

(54) Disintegrative Particles to Release Agglomeration Agent for Water Shut-Off Downhole

(71) Applicant: James B. Crews, Willis, TX (US)

(72) Inventor: James B. Crews, Willis, TX (US)

(73) Assignee: Baker Hughes Incorporated, Houston, TX (US)

(21) Appl. No.: 13/598,969

(22) Filed: Aug. 30, 2012

Related U.S. Application Data
(60) Provisional application No. 61/531,712, filed on Sep. 7, 2011.

(51) Int. Cl. E21B 43/12; C09K 8/42

(52) U.S. Cl. 166/310; 523/130; 106/33

(57) ABSTRACT

Disintegrative particles having a disintegrative coating surrounding a disintegrative core may be pumped within an aqueous treatment fluid downhole to a subterranean formation. With time and/or change in wellbore or environmental condition, these particles will either disintegrate partially or completely, in non-limiting examples, by contact with downhole wellbore fluid, formation water, or a stimulation fluid (e.g. acid or brine). Once disintegrated, metals or compounds are released which raises the fluid pH and forms a structure that selectively inhibits or shuts-off the production of water from water-producing zones. The disintegrative particles may be made by compacting and/or sintering metal powder particles, for instance magnesium or other reactive metal or their alloys. Alternatively, particles coated with nanometer-sized or micrometer sized coatings may be designed where the coatings disintegrate faster or slower than the core in a changed downhole environment.

### CROSS-REFERENCE TO RELATED APPLICATION

This application claims the benefit of U.S. Provisional Patent Application Ser. No. 61/531,712 filed Sep. 7, 2011, incorporated by reference herein in its entirety.

### TECHNICAL FIELD

The present invention relates to methods and compositions to inhibit or shut-off the flow of water in subterranean formations, and more particularly relates, in one embodiment, to methods of using aqueous fluids containing certain disintegrative particles to selectively inhibit or shut-off the flow of water in subterranean formations but not inhibit the flow of hydrocarbons during hydrocarbon recovery operations.

### TECHNICAL BACKGROUND

Certain subterranean oil producing wells are formed or completed in formations which contain both oil-producing zones and water-producing zones. Unwanted water production is a major problem in maximizing the hydrocarbon production potential of these wells. Tremendous costs may be incurred from separating and disposing of large amounts of produced water, inhibiting the corrosion of tubulars, replacing tubular equipment downhole, and surface equipment maintenance. Shutting off unwanted water production is a necessary condition to maintaining a productive field. While there is a wide array of treatments available to solve these problems, they all suffer from a number of difficulties, including, but not necessarily limited to, surface mixing and handling problems, etc.

For instance, traditional water shut-off technology with chemicals uses sodium silicate solutions and crosslinked polymers. The silicate solution is typically not compatible with formation waters, since sodium silicate reacts with calcium chloride instantly to generate gel. In this approach, the two solutions may be injected in any order and must be separated by a slug of an inert aqueous spacer liquid. U.S. Pat. No. 4,004,639 provides chemicals to achieve water shut-off in producing wells. It uses a sodium silicate base fluid solution and an ammonium sulfate gelling agent. Those two solutions are injected and separated by a slug of an inert aqueous spacer liquid.

There is also U.S. Pat. No. 4,732,213 which discloses a process for selectively plugging permeable zones in subterranean formations or for plugging subterranean leaks which involves injecting into the permeable zone or the site of the subterranean leak an aqueous solution containing 1 to 70 weight percent of a non-aggregated colloidal silica sol having a particle size in the range between 4 and 100 nm and a pH in the range between about 1 and 10, and particularly a range near neutral pH, and causing said solution to gel in said zone or at said site. However, these technologies cannot generate uniform gels to plug the porous medium and cannot place the gel deep into the formation. Several staged treatments are also required in pumping the fluids using these techniques.

Crosslinked polymers have also been used to shut off or inhibit water flow. However, crosslinked polymer technology may need separate cross-linkers from the linear polymer fluid separated by a slug of an inert spacer in a form of multi-stage pumping. Crosslinked polymer technology may also use a delayed crosslinking method which may depend on the formation temperature and fluid traveling time in the formation as factors to delay the crosslinking. As is often the case concerning hydrocarbon production, being able to deploy the effective agents, components, systems etc. at the desired location, without the agents and components reacting early and/or thus deploying at too shallow a depth may be a critical challenge.

Agglomerating agents and methods for their use in heap leaching of mineral bearing ores are known from U.S. Pat. No. 5,112,582. A moderate to high molecular weight anionic polymer in combination with lime provides a highly effective agglomerating agent. The anionic polymer is preferably a copolymer of acrylamide and acrylic acid. The polymer preferably has a molecular weight of from about 1 to 8 million or higher. This agglomeration might be useful in inhibiting or preventing water flow.

Shallow water flow is a serious drilling hazard encountered in several deep water drilling situations including those in the Gulf of Mexico. A number of incidents have occurred in which strong shallow water flows have disrupted drilling operations and added millions of dollars to the cost of a well, or caused a well to be abandoned. It would be desirable if a method and/or composition could be employed to inhibit or prevent shallow water flow in these situations as well.

Further, improvements are always needed in controlling injection profiles for steam and thermal recovery operations, and to control water injection to improve sweep efficiency during secondary and tertiary recovery of hydrocarbons.

There remains a need to find a chemical system that will simplify the pumping schedule and permit deep penetration into the formation to shut off the water channels in an effective manner and keep oil flow channels open.

### SUMMARY

There is provided in one non-limiting embodiment a method for inhibiting or preventing a flow of water in a subterranean formation, which method involves introducing a treatment fluid into at least one zone of the subterranean formation where the water is present. The treatment fluid includes an aqueous carrier fluid that may be fresh water, synthetic brine, completion brine, produced water, seawater, and/or recycled treatment water. The treatment fluid also includes disintegrative particles comprising a disintegrative coating at least partially surrounding a disintegrative core. The method then involves disintegrating the disintegrative coating and/or the disintegrative core to release metals or compounds, and increasing the pH of the treatment fluid by the action of the metals or compounds. Finally, the method involves the pH increase thereby forming a structure that inhibits or prevents the flow of water from the water producing zone of the subterranean formation into the wellbore.

There is additionally provided in one non-restrictive version, a subterranean formation treatment fluid that includes an aqueous carrier fluid which may comprise fresh water, synthetic brine, completion brine, produced water, seawater, and/or recycled treatment water. The subterranean formation treatment fluid may also include disintegrative particles comprising a disintegrative coating at least partially surrounding a disintegrative core, and the fluid may also contain a structure component selected from the group consisting of a polymer, copolymer, or terpolymer of monomers selected from the group consisting of acrylamides, saccharides, acrylates, styrenes, vinyls, acrylamido-methylpropane-sufonates, ethylene oxide and mixtures of ethylene oxide and propylene oxide; other derivatives of the polymer, copolymer, or terpolymer defined above; and a latex of the polymer, copolymer or terpolymer defined above, where a structure may be formed from the structure component by grouping together the polymer by a mechanism that includes, but is not necessarily limited to, precipitating, flocculation, agglomeration, and/or crosslinking. That is, the structure component is configured to form the structure by one of these methods or processes. The forming of the structure is designed to occur in the water-producing zones of the subterranean formation, but not the hydrocarbon-producing zones, by utilizing treatment fluid placement techniques well known in the art of water conformance. That is, the treatment fluid would be placed in or adjacent at least one water producing zone in the subterranean formation so that the treating fluid contacts the water in that zone.

### DETAILED DESCRIPTION

It has been discovered that inhibiting or preventing the flow of water in a water-producing zone of a subterranean formation may be accomplished by introducing, e.g. pumping, a treatment fluid into the subterranean formation at or adjacent to the water-producing zone, where the treatment fluid includes an aqueous carrier fluid and disintegrative particles. The disintegrative particles comprise a disintegrative coating at least partially surrounding, or completely surrounding, a disintegrative core. When the coating and/or the core disintegrate, metals and/or compounds are released which immediately or over time increase the pH of the fluid which in turn triggers or causes a structure to form that either partially or completely shuts off the flow of water from a subterranean formation.

In more detail, and in all embodiments the treatment fluid is aqueous and thus the carrier fluid of the treatment fluid may be, but is not necessarily limited to, fresh water, synthetic brine, completion brine, produced water, sea-water, recycled treatment water, and the like, and combinations thereof. As will be described in particular non-limiting embodiments a high salinity brine may be used, for instance, such as seawater, produced water, completion brine, or recycled treatment water. By “high salinity” is meant a brine with up to about 300,000 mg/l total dissolved solids.

Also in all embodiments, the disintegrative particles, either the disintegrative cores and/or the disintegrative coatings are the triggering agent to change the fluid pH to increase and consequently form a structure that inhibits or prevents the production of water from the water-producing zone.

With time these disintegrative particles will either disintegrate partially or completely in downhole formation water, treating fluid (i.e. mix water brine) and other fluids. Some of these particles may disintegrate in aqueous treating fluids if the fluids contain H₂S, CO₂, and other acids or acid gases that cause disintegration of the materials. Oxides, nitrides, carbides, intermetallics or ceramic coatings resistant to some of these fluids, or additionally or alternatively these dissolvable particles may be dissolved with another stimulation or cleanup fluid such as an acid or brine-based fluids. Once disintegrated, the pH will rise enabling formation or creation of a structure that causes preventing or inhibiting water flow.

In one non-limiting embodiment the pH is raised to over 10; alternatively the pH is raised to over 9; alternatively the pH is raised to over 7, and in another non-restrictive version, the pH is raised to over 4.

The disintegrative (disintegrate-able) portions of the particles may be selectably and controllably degradable materials that include, but are not necessarily limited to, powders, powder compacts, sintered powder compacts, and the like. In one non-limiting embodiment the powders and compacts are individual particles that have single or multilayer micron-scale and/or nanoscale coatings. The size of the individual particles can be from about 10 nanometers to 10 microns in size. Preferably the individual particles with coating layer or layers are less than the size of the formation pores so that they will have the ability to be placed deep within the reservoir pore matrix. In one non-limiting embodiment the individual average particle size is less than 10 microns; alternatively the average particle size is less than 2 microns; alternatively the average particle size is less than 600 nanometers; and in another non-restrictive version, the average particle size is less than 200 nanometers.

Alternatively, in another non-limiting embodiment, the particles are aggregates formed from coated powder materials that include various particle cores and core materials having various single layer and multilayer micron-scale and/or nanoscale coatings.

These individual and aggregated powder compacts are made from coated metallic powders that include various electrochemically-active (e.g. having relatively higher standard oxidation potentials), particle cores and core materials, or materials that comprise all of the particles, such as electrochemically active metals. In a non-limiting example, these coated powders and powder compact materials may be configured to provide a selectable and controllable degradation or disintegration in response to a change in an environmental condition, such as a transition from a very low dissolution rate to a very rapid dissolution rate in response to a change in a property or condition of a wellbore or within the reservoir matrix, including a property change in a wellbore or reservoir matrix fluid that is in contact with the powder compact. The selectable and controllable degradation characteristics described also allows a delay in degradation, such as a time delay for a predetermined environmental condition, such as a wellbore condition, including wellbore fluid temperature, pressure or pH value, salt or brine composition, and may be changed to promote their degradation by rapid dissolution. These coated powder materials and powder compacts, as well as methods of making them, are described further below. In one non-limiting embodiment, these disintegrative metals may be called controlled electrolytic metallics or CEM. To be clear, while a change in pH of the surrounding fluid may cause complete or partial disintegration of the disintegrative particles (the cores and/or the coatings), such disintegration is selectively designed to release metals or compounds that raise the pH of the fluid. The amount of pH increase may be dependent on a number of factors, such as but not limited to, CEM composition, CEM concentration, initial pH of treatment fluid, pH of wellbore fluid, pH of the formation matrix fluid, and the like.

Disintegrative particles may be created with technology previously described in U.S. Patent Application Publication No. 2011/0135953 A1, incorporated by reference herein in its entirety. Magnesium or other reactive materials could be used in the powders to make the disintegrative metal portions, for instance, magnesium, aluminum, zinc, manganese, molybdenum, tungsten, copper, iron, calcium, cobalt, tantalum, rhenium, nickel, silicon, rare earth elements, and alloys thereof and combinations thereof. The alloys may be binary, tertiary or quaternary alloys of these elements. As used herein, rare earth elements include, but are not necessarily limited to, Sc; Y; lanthanide series elements, including La, Ce, Pr, Nd, Pm, Sm, Eu, Gd, Te, Dy, Ho, Er, Tm, or Lu; or actinide series elements, including but not necessarily limited to, Ac, Th, Pa, U, Np, Pu, Am, Cm, Bk, Cf, Es, Fm, Md, or No; or a combination of rare earth elements. These metals may be used as pure metals or in any combination with one another, including various alloy combinations of these materials, including binary, tertiary, or quaternary alloys of these materials. Nanoscale metallic and/or non-metallic coatings could be applied to these electrochemically active metallic particles to provide a means to accelerate or decelerate the disintegrating rate. Disintegrative enhancement additives include, but are not necessarily limited to, magnesium, aluminum, nickel, iron, cobalt, copper, tungsten, rare earth elements, and alloys thereof and combinations thereof. It will be observed that some elements are common to both lists, that is, those metals which can form disintegrative metals and disintegrative metal compacts and those which can enhance such metals and/or compacts. The function of the metals, alloys or combinations depends upon what metal or alloy is selected as the major composition or powder particle core first. Then the relative disintegrative rate depends on the value of the standard potential of the additive or coating relative to that of the core. For instance, to make a relatively more slowly disintegrating core, the additive or coating composition needs to have lower standard potential than that of the core. An aluminum core with a magnesium coating is a suitable example. Or, to make this core dissolve faster, standard potential of the core needs to be lower than that of the coating. An example of this latter situation would be a magnesium particle with a nickel coating.

These electrochemically active metals or metals with nanoscale coatings are very reactive with a number of common wellbore fluids, including any number of ionic fluids or highly polar fluids. Examples include fluids comprising sodium chloride (NaCl), potassium chloride (KCl), hydrochloric acid (HCl), calcium chloride (CaCl₂), sodium bromide (NaBr), calcium bromide (CaBr₂), zinc bromide (ZnBr₂), potassium formate, or cesium formate.

In one non-limiting embodiment, the disintegrative particles may have an overall average particle size of 10 microns or less, alternatively 2 micron or less; alternatively 1 microns or less; alternatively 600 nanometers or less; and in another non-restrictive version, the size is less than 200 nanometers.

More specifically, a new treating fluid formulation which includes a component of individual disintegrative particles that disintegrate in downhole environments has been discovered. In one non-limiting embodiment the disintegrative particles are predominantly metallic particles, such as those made from metal powders. The dissolvable particles may be spherical, elongated, rod-like or another geometric shape. The particles have a core and a coating. The core could be of metals such magnesium, zinc, aluminum, tungsten and other metals. The coating could be of nickel, aluminum, alumina and many other compositions. The coating could be such that it accelerates or decelerates the disintegration. These particles could be such that they disintegrate either partially or completely with time. The disintegration rate may be controlled by the composition of the treating fluid, such as the type and amount of acids or salts present. The treating fluid can be fresh water or brine gelled with polymers and/or by viscoelastic surfactants, or a fluid containing an acid. For example in a two-stage process, disintegration control may be accomplished through careful selection of the particles and the fluids used. For instance, in a non-limiting example, a brine may remove a first coating of the particle, whereas an acid-containing fluid may subsequently disintegrate the rest of the particle.

In an alternative procedure, it is conceived that these disintegrative particles may be designed to be triggered by a certain kind of treatment fluid. After the disintegrative particles are placed at or adjacent to a water-producing zone, a subsequent dosing of treatment fluid, different from the carrier or placement fluid, will trigger the dissolution of the disintegrative particle phase. This additional activation fluid treatment may be an acid or brine or seawater or even heated water or steam, or even fresh water—something that provides chemical and/or physical stimuli for dissolvable material to be triggered. The acid may be a mineral acid (where examples include, but are not necessarily limited to HCl, H₂SO₄, H₂PO₄, HF and the like), and/or an organic acid (where examples include, but are not necessarily limited to acetic acid, formic acid, fumaric acid, succinic acid, glutaric acid, adipic acid, citric acid, and the like). In another embodiment, the acid or brine may be as the internal phase of an emulsion treatment fluid in one non-limiting method of targeting release of the corrosive liquid later in time or at a remote location.

In one non-restrictive version, the disintegrative coating ranges from about 1 nm independently to about 1000 nm thick, alternatively from about 10 nm independently to about 500 nm thick, and alternately from about 15 nm independently to about 100 nm thick. When the term “independently” is used herein with respect to a parameter range, it is to be understood that all lower thresholds may be used together with all upper thresholds to form suitable and acceptable alternative ranges. These coatings may be formed by any acceptable method known in the art and suitable methods include, but are not necessarily limited to, chemical vapor deposition (CVD) including fluidized bed chemical vapor deposition (FBCVD), as well as physical vapor deposition, laser-induced deposition and the like, as well as sintering and/or compaction. In another non-limiting version, the particle may be formed of two approximately equal, or even unequal, hemispheres.

It will be further understood that although the disintegrative particles may be spheres or generally spherical, they may be other shapes including, but not necessarily limited to, irregular rod-like, acicular, dentritic, flake, nodular, irregular, and/or porous, including elongated versions of these, and the like with and without smoothed corners, and still be effective as described herein. In another non-limiting version, the particle may be hollow or porous.

In another non-restrictive embodiment, the disintegrative portions of the disintegrative particles are made from disintegrative metals. Each powder particle may comprise a particle core, where the particle core comprises a core material comprising Mg, Al, Zn or Mn, or a combination thereof, having a melting temperature (T_{P}). The powder particle may additionally comprise a metallic coating layer disposed on the powder particle core and comprising a metallic coating material having a melting temperature (T_{C}), wherein the powder particles are configured for solid-state sintering to one another at a predetermined sintering temperature (T_{S}), and T_{S} is less than T_{P} and T_{C}. Alternatively, T_{S} is slightly higher that T_{P} and T_{C} for localized micro-liquid state sintering, By “slightly higher” is meant about 10 to about 50° C. higher than the lowest melting point of all the phases involved in the material for localized micro-liquid sintering.

There are at least three different temperatures involved: T_{P} for the particle core, T_{C} for the coating, and a third one T_{PC} for the binary phase of P and C. T_{PC} is normally the lowest temperature among the three. In a non-limiting example, for a Mg particle with aluminum coating, according to Mg—Al phase diagram, T_{P}=650° C., T_{C}=660° C. and T_{CP}=437 to <650° C. depending on the wt % ratio of the Mg—Al system. Therefore, for completed solid-state sintering, the predetermined process temperature needs to be less than T_{PC}. For micro-liquid phase sintering at the core-coating interface, the temperature may be 10-50 degrees C. higher than T_{PC} but less than T_{P} and T_{C}. A temperature higher than T_{P} or T_{C} may be too much, causing macro melting and destroying the coating structure.

Again, further details about making these dissolvable metal portions may be had with reference to U.S. Patent Application Publication No. 2011/0135953 A1, incorporated by reference herein in its entirety.

After positioning of the disintegrative particles, at least a portion of them are disintegrated and the effective metals or compounds released therefrom. This may be accomplished preferentially by the carrier fluid, but alternately can be by a second fluid or formation brine. The fluid may contain corrosive material, such as select types and amounts of acids and salts, to control the rate of disintegration of the particles. In another embodiment this can be accomplished by removing or displacing the carrier fluid or the placement fluid that introduced the disintegrative particles and subsequently introducing a different fluid to dissolve the dissolvable particles. This subsequent fluid may suitably be, but is not necessarily limited to, fresh water, brines, acids, hydrocarbons, emulsions, and combinations thereof so long as it is designed to dissolve all or at least a portion of the disintegrative particles. While all of the disintegrative particles may be disintegrated, as a practical matter in an alternate embodiment it may not be possible to contact and disintegrate all of the dissolvable particles with the subsequent fluid and thus remove or disintegrate all of them. It is only necessary that an effective amount of the disintegrative particles, coatings and/or cores be disintegrated to accomplish the stated purpose of the method.

It will be additionally appreciated that in one non-limiting embodiment the fluid that disintegrates the disintegrative particles or the relatively differently disintegrative portions of the particles may be a fluid that may also be a stimulation fluid, such as an acid, in which case the fluid may have a dual function. It is further understood that the disintegrative particles (or portions thereof) may be designed to be triggered by a certain kind of stimulation fluid. After the particles are positioned or placed, a subsequent dosing of stimulation fluid will trigger the disintegration of the disintegrative particles, or alternatively certain portions thereof. This additional stimulation fluid treatment may be an acid, brine or seawater or even heated water or steam—a fluid that provides chemical and/or physical stimuli for the disintegrative material to be triggered or disintegrated.

In all embodiments herein, it is the disintegration of the disintegrative particles, what is released by either one or more disintegrative coating and/or the disintegrative core, that serves as the triggering agent to change the fluid pH and in turn forms a structure that selectively inhibits or prevents the flow of water in the subterranean formation. In one non-limiting embodiment a principal mechanism for aqueous fluid pH change is disintegration of a CEM particle having a primarily elemental magnesium core which, once exposed, after the outer metallic coating disintegrates, will then react with water by hydrolysis to form magnesium hydroxide (Mg(OH)₂)—which then raises fluid pH. The composition of the disintegrative coating and its disassociation rate may give a controllable and delayed method to raise fluid pH; this is an important distinction over prior water shut-off methods and compositions.

In this non-limiting embodiment, the primary CEM core composition will be elemental Mg and the reaction may be represented as:

Mg (elemental)+2H₂O→Mg(OH)₂+H₂(gas) (I)

Other optional metals or compounds or combinations thereof which may comprise the disintegrative core which will also effectively raise fluid pH include, but are not necessarily limited to, magnesium (Mg), calcium (Ca), strontium (Sr), magnesium oxide (MgO), calcium oxide (CaO), calcium hydroxide (Ca(OH)₂), sodium hydroxide (NaOH), sodium bicarbonate (NaHCO₃), potassium hydroxide (KOH), potassium carbonate (K₂CO₃), sodium sesquicarbonate (Na₃H(CO₃)₂), trisodium phosphate (Na₃PO₄), borax (Na₂B₄O₇.10H₂O), ulexite (NaCaB₅O₆(OH)₆5.H₂O), and urea.

In another embodiment, disintegrative particles may be mixed or combined with one or more polymers, such as polymers, copolymers or terpolymers of monomers selected from the group consisting of acrylamides, acrylates, styrenes, vinyls, acrylamido-methylpropane-sufonates (AMPS), ethylene oxide, mixtures of ethylene oxide and propylene oxide, saccharides; other derivatives of these; latexes of these and combinations thereof. The structure formed to inhibit or prevent water flow may involve grouping together the polymer by a mechanism that includes, but is not necessarily limited to, flocculation, agglomeration, crosslinking, precipitating, and combinations thereof. These polymers may thus be components or parts of this ultimate structure. A principal mechanism is polymer flocculation and/or aggregation when fluid pH is raised, for instance above 9.0, in one non-limiting embodiment. The polymer may be initially in a stable dispersed state during placement of the treatment fluid within the reservoir. Then when the fluid pH rises, the polymer will precipitate, crosslink, flocculate and/or agglomerate and thus become pore plugging. That is, the water will be unable to pass through the reservoir pore matrix.

In a different non-limiting version, a combination of specialized CEM disintegrative particles together with a cross-linkable polymer may be used. The specialized CEM disintegrative particles would contribute a delayed release of crosslinker elements, including, but not necessarily limited to, B (boron), Ti (titanium), Zr (zirconium), Al (aluminum), Cr (chromium) and combinations thereof. The fluid may also contain one or more alkaline pH buffers including, but not necessarily limited to, calcium, strontium, magnesium oxide (MgO), magnesium hydroxide (Mg(OH)₂), calcium oxide (CaO), calcium hydroxide (Ca(OH)₂), sodium hydroxide (NaOH), potassium hydroxide (KOH), sodium carbonate (Na₂CO₃), potassium carbonate (K₂CO₃), sodium bicarbonate (NaHCO₃), sodium sesquicarbonate (Na₃H(CO₃)₂), and combinations thereof.

In this embodiment, the crosslinking elements may come from the disintegrative coating and/or the disintegrative core. In another non-restrictive version it is expected that the above-mentioned pH buffer would come primarily from the disintegrative core. The crosslinkable polymers may be any of those commonly used in the oil industry and include, but are not necessarily limited to, polysaccharides, polyacrylamides, polyvinyls, and the like. The amount of polymer in the treatment fluid may range from about 10 pptg independently to about 400 pptg (about 1.2 independently to about 48 kg/m³), and in another non-restrictive version may range from about 40 pptg independently to about 160 pptg (about 4.8 independently to about 19.2 kg/m³).

In yet an additional non-limiting embodiment two different types of particles may be used, where the average particle size of both particle types is about 10 microns or less, alternatively about 1 micron or less. The two different particle types do not have to have similar or the same average particle sizes or shapes. One of the particle types is the CEM disintegrative particles previously discussed. The second or secondary particle type may include, but not necessarily be limited to, silica, silicates, oxides, hydroxides, carbonates and combinations thereof. Further, the surface of the second particle type may be modified to aid initial dispersibility in the treatment fluid. For instance, the surface may be modified so that there are terminal hydroxyl groups to make the second particle types more dispersible in aqueous fluids. In practice, the second particle would be in a stable, dispersed state during treatment fluid placement within the reservoir—but will flocculate and/or agglomerate when the fluid pH rises, and thus will become pore plugging to shut off or inhibit water flow. Again, the rise in fluid pH that changes the stability of the second particle would be controlled by use of CEM particles.

A still different non-restrictive version may be similar to the one described above except that the aqueous treatment fluid contains a discontinuous non-aqueous internal phase where the majority of the disintegrative particles are within the discontinuous non-aqueous internal phase. In one non-limiting embodiment the non-aqueous internal phase is an oil. The use of an oil internal or non-aqueous internal discontinuous phase will allow additional delay of the forming of the structure that inhibits or prevents water flow. This particular embodiment of the method may be particularly useful where the reservoir temperature is about 250° F. or above (about 121° C. or above) and when high salinity brine is used as the aqueous fluid as previously defined, for instance seawater, produced water, completion brine, or recycled treatment water.

Optionally in all embodiments, all or portions of the treatment fluid may be viscosified to aid with treatment fluid placement. The viscosifiers that may be used to increase the viscosity of the treatment fluid may include, but not necessarily limited to, viscoelastic surfactants (VESs), polysaccharides, polyacrylamides, copolymers and the like which are known in the art. These optional viscosifiers may be the same as or different from the polymer of the structural component previously discussed.

Other optional components of the treatment fluids described herein may include, but not necessarily be limited to, salts, acids, surfactants, polyols, crosslinkers, chelants, oxidizers, reducing agents, amines, esters, and combinations thereof. These optional components may be employed for a variety of purposes, including, but not necessarily limited to, improving the dispersibility of the CEM disintegrative particles, improving the dispersibility of the secondary particle types described previously, increasing the rate of the disintegrative coating(s) and/or increasing the rate of the disintegrative core, and the like.

In the foregoing specification, the invention has been described with reference to specific embodiments thereof, and has been demonstrated as effective in providing methods and compositions for preventing or inhibiting water flow in a subterranean formation. However, it will be evident that various modifications and changes can be made thereto without departing from the broader spirit or scope of the invention as set forth in the appended claims. Accordingly, the specification is to be regarded in an illustrative rather than a restrictive sense. For example, specific combinations of disintegrative particles and particle types, second particles, carrier fluids and disintegration fluids and other components falling within the claimed parameters, but not specifically identified or tried in a particular composition or method, are expected to be within the scope of this invention. Further, it is expected that the components and proportions of the disintegrative particles or portions thereof and procedures for forming structures that shut-off or inhibit water flow may change somewhat from one application to another and still accomplish the stated purposes and goals of the methods described herein. For example, the methods may use different components, component combinations, different component proportions and additional or different steps than those described and exemplified herein.

The words “comprising” and “comprises” as used throughout the claims is to be interpreted as “including but not limited to”.

The present invention may suitably comprise, consist or consist essentially of the elements disclosed and may be practiced in the absence of an element not disclosed. For instance, a method for inhibiting or preventing a flow of water in a subterranean formation may consist of or consist essentially of introducing into water producing zones of the subterranean formation a treatment fluid, where the treatment fluid comprises a carrier fluid and disintegrative particles as described in the claims, where the method additionally consists of or consists essentially of disintegrating the disintegrative coating or the disintegrative core to release metals or compounds, increasing the pH of the treatment fluid by the action of the metals or compounds and thereby forming a structure that inhibits or prevents the flow of water in the subterranean formation.

Alternatively, a subterranean formation treatment fluid useful herein may consist or consist essentially of a carrier fluid (as defined in the claims), disintegrative particles (as defined in the claims) and a structure component that is a polymer, copolymer and/or terpolymer from a monomer selected from the group consisting of acrylamides, vinyls, saccharides, acrylates, styrenes, acrylamido-methylpropane-sufonate, ethylene oxide, mixtures of ethylene oxide and propylene oxide, and other derivatives of these polymers, copolymers and terpolymers, latexes of these polymers, copolymers and terpolymers and combinations thereof, where a structure may be formed from the structure component by grouping together the polymer by a mechanism selected from the group consisting of flocculation, agglomeration, crosslinking, precipitating, and combinations thereof.

What is claimed is:

1. A method for inhibiting or preventing a flow of water in a subterranean formation comprising:
introducing into at least one water producing zone of the subterranean formation where the water is present a treatment fluid, where the treatment fluid comprises:
an aqueous carrier fluid selected from the group consisting of fresh water, synthetic brine, completion brine, produced water, seawater, recycled treatment water, and
disintegrative particles comprising a disintegrative coating at least partially surrounding a disintegrative core;
disintegrating the disintegrative coating and the disintegrative core to release metals or compounds;
increasing the pH of the treatment fluid by the action of the metals or compounds; and thereby
forming a structure that inhibits or prevents the flow of water from the water producing zone of the subterranean formation.

2. The method of claim 1 where the disintegrative core comprises: metals and compounds selected from the group consisting of: magnesium; calcium; strontium; aluminum; zinc; manganese; molybdenum; tungsten; copper; iron; calcium; cobalt; tantalum; rhenium; nickel; binary; tertiary or quaternary alloys of the elements selected from the group consisting of magnesium, calcium, strontium, aluminum, zinc, manganese, molybdenum, tungsten, copper, iron, calcium, cobalt, tantalum, rhenium, and nickel; magnesium oxide (MgO); calcium oxide (CaO); calcium hydroxide (Ca(OH)₂); sodium hydroxide (NaOH); sodium bicarbonate (NaHCO₃); potassium hydroxide (KOH); potassium carbonate (K₂CO₃); sodium sesquicarbonate (Na₃H(CO₃)₂); trisodium phosphate (Na₃PO₄); borax (Na₂B₄O₇.10H₂O); ulexite (NaCaB₅O₆(OH)₆.5H₂O); urea; and combinations thereof.

3. The method of claim 1 where the treatment fluid further comprises a structure component that is a polymer selected from the group consisting of latexes, polyacrylamides, polysaccharides, polyacrylates, polystyrenes, polyvinyls, acrylamido-methylpropane-sufonates, polyethylene oxides, polyethyleneoxide-propylene oxides; copolymers of these, terpolymers of these, and combinations thereof, where forming the structure further comprises grouping together the polymer by a mechanism selected from the group consisting of flocculation, agglomeration, crosslinking, precipitating, and combinations thereof.

4. The method of claim 3 where the disintegrative coating or the disintegrative core comprises a crosslinker selected from the group consisting of metals or compounds comprising an element selected from the group consisting of B, Ti, Zr, Al, Cr and combinations thereof, and the forming the structure further comprises crosslinking the polymer.

5. The method of claim 4 where the treatment fluid further comprises at least one alkaline pH buffer selected from the group consisting of calcium, strontium, magnesium oxide (MgO), magnesium hydroxide (Mg(OH)₂), calcium oxide (CaO), calcium hydroxide (Ca(OH)₂), sodium hydroxide (NaOH), potassium hydroxide (KOH), sodium carbonate (Na₂CO₃), potassium carbonate (K₂CO₃), sodium bicarbonate (NaHCO₃), sodium sesquicarbonate (Na₃H(CO₃)₂), and combinations thereof.

6. The method of claim 5 where the disintegrative coating is selected from group consisting magnesium, aluminum, zinc, manganese, molybdenum, tungsten, copper, iron, calcium, cobalt, tantalum, rhenium, nickel, silicon, rare earth elements, oxides thereof, nitrides thereof, carbides thereof, and alloys thereof and combinations thereof.

7. The method of claim 6 where the disintegrative coating is formed by a process selected from the group consisting of chemical vapor deposition (CVD), fluidized bed chemical vapor deposition (FBCVD), physical vapor deposition, laser-induced deposition and combinations thereof.

8. The method of claim 4 where the disintegrative core comprises at least one alkaline pH buffer selected from the group consisting of calcium, strontium, magnesium oxide (MgO), magnesium hydroxide (Mg(OH)₂), calcium oxide (CaO), calcium hydroxide (Ca(OH)₂), sodium hydroxide (NaOH), potassium hydroxide (KOH), sodium carbonate (Na₂CO₃), potassium carbonate (K₂CO₃), sodium bicarbonate (NaHCO₃), sodium sesquicarbonate (Na₃H(CO₃)₂), and combinations thereof.

9. The method of claim 3 where the amount of polymer in the treatment fluid ranges from about 10 pptg to about 400 pptg.

10. The method of claim 1 where the disintegrative coating ranges from about 1 nm to about 1000 nm thick.

11. The method of claim 1 where the disintegrative core or disintegrative coating of the disintegrative particles comprises disintegrative metal.

12. The method of claim 11 where the disintegrative metal is a sintered powder compact where the metal is selected from the group consisting of magnesium; aluminum; zinc; manganese; molybdenum; tungsten; copper; iron; calcium; cobalt; tantalum; rhenium; nickel; silicon; rare earth elements; alloys of the elements selected from the group consisting of magnesium, aluminum, zinc, manganese, molybdenum, tungsten, copper, iron, calcium, cobalt, tantalum, rhenium, nickel, silicon, and rare earth elements; and combinations thereof.

13. The method of claim 12 where the disintegrative metal is sintered from a metallic composite powder comprising a plurality of metallic powder particles, each powder particle comprising:
a particle core, the particle core comprises a core material comprising an element selected from the group consisting of Mg, Al, Zn or Mn, or a combination thereof, having a melting temperature (T_{P}); and
a metallic coating layer disposed on the particle core and comprising a metallic coating material having a melting temperature (T_{S}), wherein the powder particles are configured for solid-state sintering to one another at a predetermined sintering temperature (T_{S}), and T_{S} is less than T_{P} and T_{C}, or for T_{S} is slightly higher that T_{P} and T_{C} for localized micro-liquid state sintering.

14. The method of claim 1 where the disintegrative particles are selected from the group consisting of:
a relatively less disintegrative core and a relatively more disintegrative coating at least partially surrounding at least a majority of the relatively less disintegrative core;
a relatively more disintegrative core and a relatively less disintegrative coating at least partially surrounding at least a majority of the relatively more disintegrative core;
a compact of relatively less disintegrative powders, where the compact itself is relatively more disintegrative;
a disintegrative metal or alloy having disintegration enhancement additives; and
combinations thereof.

15. The method of claim 1 where the treatment fluid further comprises a second particle selected from the group consisting of silica, silicates, oxides, hydroxides, carbonates and combinations thereof, and where forming the structure further comprises flocculating or agglomerating the second particle when the pH of the treatment fluid increases thereby causing inhibiting or preventing the flow of water in the subterranean formation.

16. The method of claim 1 where the treatment fluid further comprises a discontinuous non-aqueous internal phase where the majority of the disintegrative particles are within the discontinuous non-aqueous internal phase.

17. A method for inhibiting or preventing a flow of water in a subterranean formation comprising:
introducing into at least one water producing zone of the subterranean formation where the water is present a treatment fluid, where the treatment fluid comprises:
an aqueous carrier fluid selected from the group consisting of fresh water, synthetic brine, completion brine, produced water, seawater, recycled treatment water,
disintegrative particles comprising a disintegrative coating at least partially surrounding a disintegrative core, and
a structure component selected from the group consisting of a polymer, copolymer, or terpolymer of monomers selected from the group consisting of acrylamides, saccharides, acrylates, styrenes, vinyls, acrylamido-methylpropane-sufonates, ethylene oxide and mixtures of ethylene oxide and propylene oxide; and a latex of the polymer, copolymer or terpolymer defined above;
where the disintegrative coating or the disintegrative core comprises a crosslinker selected from the group consisting of metals or compounds comprising an element selected from the group consisting of B, Ti, Zr, Al, Cr and combinations thereof, and the forming the structure further comprises crosslinking the polymer
disintegrating the disintegrative coating and the disintegrative core to release metals or compounds;
increasing the pH of the treatment fluid by the action of the metals or compounds; and thereby
forming a structure that inhibits or prevents the flow of water from the water producing zone of the subterranean formation, where forming the structure further comprises grouping together the polymer by a mechanism selected from the group consisting of flocculation, agglomeration, crosslinking, precipitating, and combinations thereof.

18. A subterranean formation treatment fluid, where the treatment fluid comprises:
an aqueous carrier fluid selected from the group consisting of fresh water, synthetic brine, completion brine, produced water, seawater, recycled treatment water;
disintegrative particles comprising a disintegrative coating at least partially surrounding a disintegrative core; and
a structure component selected from the group consisting of a polymer, copolymer, or terpolymer of monomers selected from the group consisting of acrylamides, saccharides, acrylates, styrenes, vinyls, acrylamido-methylpropane-sufonates, ethylene oxide and mixtures of ethylene oxide and propylene oxide; and a latex of the polymer, copolymer or terpolymer defined above, where a structure may be formed from the structure component by grouping together the polymer, copolymer or terpolymer by a mechanism selected from the group consisting of precipitating, flocculation, agglomeration, crosslinking, precipitating, and combinations thereof.

19. The subterranean formation treatment fluid of claim 18 where the disintegrative core comprises: metals and compounds selected from the group consisting of: magnesium; calcium; strontium; aluminum; zinc; manganese; molybdenum; tungsten; copper; iron; calcium; cobalt; tantalum; rhenium; nickel; binary; tertiary or quaternary alloys of the elements selected from the group consisting of magnesium, calcium, strontium, aluminum, zinc, manganese, molybdenum, tungsten, copper, iron, calcium, cobalt, tantalum, rhenium, and nickel; magnesium oxide (MgO); calcium oxide (CaO); calcium hydroxide (Ca(OH)₂); sodium hydroxide (NaOH); sodium bicarbonate (NaHCO₃); potassium hydroxide (KOH); potassium carbonate (K₂CO₃); sodium sesquicarbonate (Na₃H(CO₃)₂); trisodium phosphate (Na₃PO₄); borax (Na₂B₄O₇.10H₂O); ulexite (NaCaB₅O₆(OH)₆.5H₂O); urea; and combinations thereof.

20. The subterranean formation treatment fluid of claim 18 where the disintegrative coating or the disintegrative core comprises a crosslinker selected from the group consisting of B, Ti, Zr, Al, Cr and combinations thereof, where the crosslinker is configured to crosslink the polymer.
